(19) United States
(12) Patent Application Publication
(10) Pub. No.: US 2025/0283230 A1
(43) Pub. Date: Sep. 11, 2025

(54) METHOD FOR PRODUCING ELECTROLYSIS CELL

(71) Applicant: HONDA MOTOR CO., LTD., TOKYO (JP)

(72) Inventor: Shintaro SUMI, WAKO-SHI (JP)

(21) Appl. No.: 19/052,923

(22) Filed: Feb. 13, 2025

(30) Foreign Application Priority Data
Mar. 11, 2024 (JP) 2024-037066

(51) Int. Cl. C25B 9/23; C25B 15/08

(52) U.S. Cl. CPC C25B 9/23; C25B 15/08

(57) ABSTRACT

A method for producing an electrolysis cell includes a joining step of joining a frame portion of a protective sheet member provided between a membrane electrode assembly and a fluid-supply-side current collector to a portion of the membrane electrode assembly on the outer side of the covered portion where an electrolyte membrane is covered with an electrode catalyst layer to form a joint, and a joined body stacking step of stacking the membrane electrode assembly and the protective sheet member joined together on the fluid-supply-side current collector with the protective sheet member facing the fluid-supply-side current collector.

### CROSS-REFERENCE TO RELATED APPLICATIONS

This application is based upon and claims the benefit of priority from Japanese Patent Application No. 2024-037066 filed on Mar. 11, 2024, the contents of which are incorporated herein by reference.

### BACKGROUND OF THE INVENTION

### Field of the Invention

The present disclosure relates to a method for producing an electrolysis cell.

### Description of the Related Art

There is an electrolysis stack including a stack body in which a plurality of electrolysis cells are stacked. Examples of the electrolysis cell include a water electrolysis cell that electrolyzes water and an electrochemical hydrogen compressor cell that electrolyzes hydrogen (hydrogen gas). The electrolysis stack including a stack body in which a plurality of water electrolysis cells are stacked is sometimes referred to as a water electrolysis device. The electrolysis stack including a stack body in which a plurality of electrochemical hydrogen compressor cells are stacked is sometimes referred to as an electrochemical hydrogen compressor (EHC).

JP 2019-157212 A discloses a water electrolysis device including water electrolysis cells. In this water electrolysis device, a plurality of water electrolysis cells are stacked. The water electrolysis cell includes a membrane electrode assembly, a pair of current collectors provided on both sides of the membrane electrode assembly, and a protection sheet member provided between one of the pair of current collectors and the membrane electrode assembly.

### SUMMARY OF THE INVENTION

The electrolysis cell is produced by stacking the membrane electrode assembly, the pair of current collectors, and the protective sheet member in a predetermined order. It is desired to reduce the risk of misalignment in producing the electrolysis cell.

The present invention has the object of solving the aforementioned problem.

According to an aspect of the present disclosure, there is provided a method for producing an electrolysis cell including: a membrane electrode assembly including an electrolyte membrane with a through hole and a pair of electrode catalyst layers provided respectively on both surfaces of the electrolyte membrane and covering the electrolyte membrane in a range extending between a portion surrounding a periphery of the through hole to a marginal edge portion of an outer circumferential edge; a pair of current collectors provided on both sides of the membrane electrode assembly; and a protective sheet member disposed between one of the pair of current collectors and the membrane electrode assembly, wherein the one of the pair of current collectors is a fluid-supply-side current collector to which a fluid to be used for electrolysis is supplied, and the protective sheet member includes an inner portion facing the electrolyte membrane in the range covered with the electrode catalyst layers and a frame portion surrounding the inner portion, the method for producing the electrolysis cell including a joining step of forming a joint by joining the frame portion to a portion of the membrane electrode assembly at a position outward of the range covered with the catalyst layers; and a joined body stacking step of stacking on the fluid-supply-side current collector the membrane electrode assembly and the protective sheet member that have been joined, in a manner that the protective sheet member faces the fluid-supply-side current collector.

According to the aspect of the present disclosure, even if there is no dedicated positioning member for the protective sheet member, the misalignment of the protective sheet member can be prevented. As a result, it becomes possible to reduce the risk of misalignment in producing the electrolysis cell.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an electrolysis stack according to an embodiment;

FIG. 2 is an exploded perspective view of an electrolysis cell forming the electrolysis stack;

FIG. 3 is a cross-sectional view taken along line III-III of FIG. 2;

FIG. 4 is a flowchart illustrating a procedure of a method for producing the electrolysis cell;

FIG. 5 is a diagram showing a joined body joined at a joint;

FIG. 6 is a diagram showing another joined body joined at a joint;

FIG. 7 is a diagram showing a state after a first arrangement step; and

FIG. 8 is a diagram showing a state in which the joined body shown in FIG. 5 is stacked.

### DETAILED DESCRIPTION OF THE INVENTION

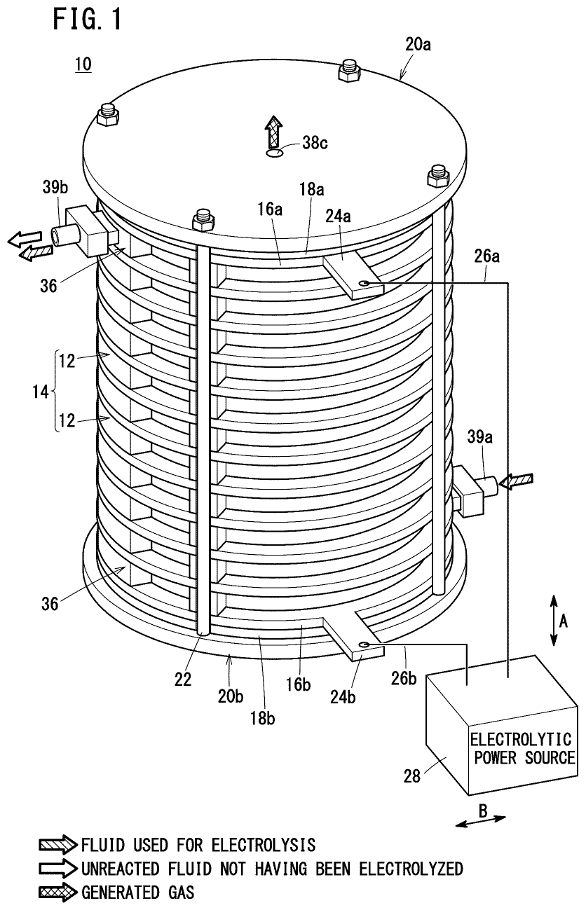

As shown in FIG. 1, an electrolysis stack 10 according to the present embodiment includes a stack body 14 in which a plurality of electrolysis cells 12 are stacked in a vertical direction (arrow A direction) or a horizontal direction (arrow B direction). The electrolysis cell 12 may be a water electrolysis cell. Alternatively, the electrolysis cell 12 may be an electrochemical hydrogen compressor cell.

The electrolysis stack 10 includes a plurality of electrolysis cells 12, a pair of terminal plates 16a, 16b, a pair of insulating plates 18a, 18b, and a pair of end plates 20a, 20b. The terminal plate 16a, the insulating plate 18a, and the end plate 20a are sequentially arranged in this order upward at one end (upper end) of the stack body 14 in the stacking direction. Similarly, a terminal plate 16b, an insulating plate 18b, and an end plate 20b are sequentially arranged in this order downward at the other end (lower end) of the stack body 14 in the stacking direction.

The electrolysis stack 10 is fastened in the stacking direction. For example, the electrolysis stack 10 is held in a state where the end plates 20a, 20b are integrally fastened by a pressing mechanism such as a plurality of tie rods 22 extending in the arrow A direction. Moreover, the electrolysis stack 10 may also be retained together integrally by a box-like casing (not shown) formed of plates serving as the end plates 20a, 20b. Further, although the electrolysis stack 10 has a substantially cylindrical columnar shape as a whole, the overall shape thereof can be set to any of various shapes, such as a cubic shape.

Terminal portions 24a, 24b are provided in an outwardly projecting manner on side portions of the terminal plates 16a, 16b. The terminal portions 24a, 24b are electrically connected via wirings 26a, 26b to an electrolytic power source 28.

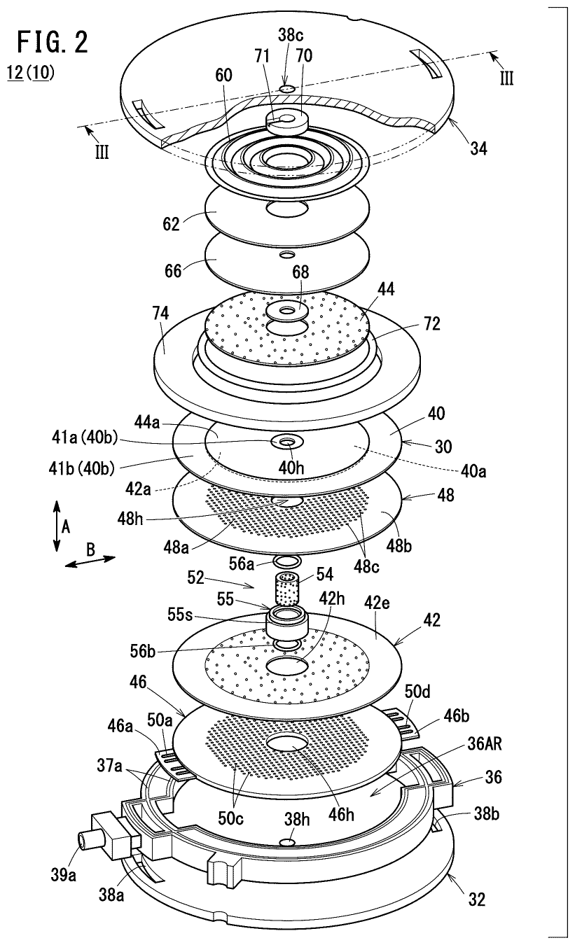

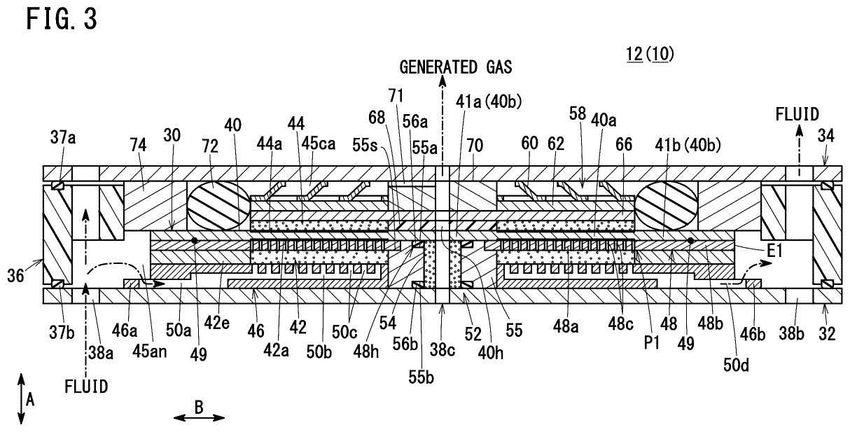

As shown in FIGS. 2 and 3, each of the electrolysis cells 12 includes a substantially disc-shaped membrane electrode assembly 30, and a first separator 32 and a second separator 34 which sandwich the membrane electrode assembly 30 and the like therebetween. Between the first separator 32 and the second separator 34, a resin frame member 36 is disposed in surrounding relation to the membrane electrode assembly 30.

The resin frame member 36 is of a substantially ring-like shape, and seal members 37a, 37b (see FIG. 3) are provided respectively on both surfaces of the resin frame member 36. One end in a diametrical direction (the arrow B direction) of the resin frame member 36 is provided with a fluid inlet 38a extending in the stacking direction (the arrow A direction). The fluid inlet 38a is formed to introduce a fluid used for electrolysis. The fluid inlets 38a of the plurality of stacked electrolysis cells 12 communicate with each other. The other end in the diametrical direction (the arrow B direction) of the resin frame member 36 is provided with a fluid outlet 38b extending in the stacking direction (the arrow A direction). The fluid outlet 38b is formed to discharge a mixed fluid containing an unreacted fluid that has not been electrolyzed. The fluid outlets 38b of the plurality of stacked electrolysis cells 12 communicate with each other.

As shown in FIG. 1, a fluid introduction opening 39a is provided on a side of the resin frame member 36 of the lowermost electrolysis cell 12 positioned at one end (lower end) in the stacking direction (arrow A direction) among the plurality of electrolysis cells 12. The fluid introduction opening 39a is connected to the fluid inlets 38a (see FIGS. 2 and 3). A fluid lead-out opening 39b is provided on a side of the resin frame member 36 of the uppermost electrolysis cell 12 positioned at the other end (upper end) in the stacking direction (arrow A direction) among the plurality of electrolysis cells 12. The fluid lead-out opening 39b is connected to the fluid outlets 38b (see FIGS. 2 and 3).

As shown in FIGS. 2 and 3, a high pressure fluid discharging hole 38c penetrates through the diametrical central portion of the electrolysis cells 12 in the stacking direction. The high pressure fluid discharging hole 38c is formed to increase the pressure of a gas generated by electrolysis of the fluid used for electrolysis and discharge the gas. The high pressure fluid discharging holes 38c of the plurality of stacked electrolysis cells 12 communicate with each other. The gas flowing to the high pressure fluid discharging hole 38c is discharged in a state of being pressurized to, for example, 1 MPa to 80 MPa.

The first separator 32 and the second separator 34 are substantially disc-shaped and are made, for example, of carbon members or the like. Apart therefrom, the first separator 32 and the second separator 34 may be formed by press forming steel plates, stainless steel plates, titanium plates, aluminum plates, steel plates subjected to a plating process, or alternatively, metal plates subjected to an anti-corrosive surface treatment on the metal surfaces thereof. Alternatively, the first separator 32 and the second separator 34 may also be formed by applying an anti-corrosive surface treatment after having carried out a cutting process.

A substantially ring shaped electrolyte membrane 40 made of a solid polymer, a first electrode catalyst layer 42a, a second electrode catalyst layer 44a form the membrane electrode assembly 30. The membrane electrode assembly 30 is disposed between the first current collector 42 and the second current collector 44.

The electrolyte membrane 40 is an ion exchange membrane. The first electrode catalyst layer 42a is an electrode catalyst layer (fluid-supply-side electrode catalyst layer) to which a fluid used for electrolysis is supplied. The first current collector 42 is a current collector (fluid-supply-side current collector) to which a fluid used for electrolysis is supplied. The second electrode catalyst layer 44a is an electrode catalyst layer on the opposite side from the first electrode catalyst layer 42a. The second current collector 44 is a current collector on the opposite side from the first current collector 42. The first electrode catalyst layer 42a may be simply referred to as the electrode catalyst layer 42a. The same applies to the second electrode catalyst layer 44a. The first current collector 42 may be simply referred to as a current collector 42. The same applies to the second current collector 44.

When the electrolysis cell 12 is a water electrolysis cell, the electrolyte membrane 40 may be an anion exchange membrane or a proton exchange membrane. In the case where the electrolyte membrane 40 is an anion exchange membrane, the fluid used for electrolysis is alkaline water. In the case where the electrolyte membrane 40 is an anion exchange membrane, the electrode catalyst layer 42a and the current collector 42 function as the anode, and the electrode catalyst layer 44a and the current collector 44 function as the cathode, the gas flowing through the high pressure fluid discharging hole 38c (see FIG. 1) is hydrogen generated by electrolysis. In this case, the mixed fluid discharged from the fluid lead-out opening 39b (see FIG. 1) contains unreacted water that has not been electrolyzed and oxygen that has been generated by electrolysis. On the other hand, in the case where the electrolyte membrane 40 is an anion exchange membrane, the electrode catalyst layer 42a and the current collector 42 function as the cathode, and the electrode catalyst layer 44a and the current collector 44 function as the anode, the gas flowing through the high pressure fluid discharging hole 38c (see FIG. 1) is oxygen that is generated by electrolysis. In this case, the mixed fluid discharged from the fluid lead-out opening 39b (see FIG. 1) contains unreacted water that has not been electrolyzed and hydrogen generated by electrolysis.

In the case where the electrolysis cell 12 is a water electrolysis cell and the electrolyte membrane 40 is a proton exchange membrane, the fluid used for electrolysis is water containing a predetermined amount or less of impurities (for example, pure water). In the case where the electrolyte membrane 40 is a proton exchange membrane, the electrode catalyst layer 42a and the current collector 42 function as the anode, and the electrode catalyst layer 44a and the current collector 44 function as the cathode, the gas flowing through the high pressure fluid discharging hole 38c (see FIG. 1) is hydrogen generated by electrolysis. In this case, the mixed fluid discharged from the fluid lead-out opening 39b (see FIG. 1) contains unreacted water that has not been electrolyzed and oxygen that has been generated by electrolysis. On the other hand, in the case where the electrolyte membrane 40 is a proton exchange membrane, the electrode catalyst layer 42a and the current collector 42 function as the cathode, and the electrode catalyst layer 44a and the current collector 44 function as the anode, the gas flowing through the high pressure fluid discharging hole 38c (see FIG. 1) is oxygen that is generated by electrolysis. In this case, the mixed fluid discharged from the fluid lead-out opening 39b (see FIG. 1) contains unreacted water that has not been electrolyzed and hydrogen generated by electrolysis.

In the case where the electrolysis cell 12 is an electrochemical hydrogen compressor cell, the electrolyte membrane 40 is a proton exchange membrane. In this case, the fluid used for electrolysis is hydrogen. The electrode catalyst layer 42a and the current collector 42 function as the anode, and the electrode catalyst layer 44a and the current collector 44 function as the cathode. The gas supplied to the high pressure fluid discharging hole 38c (see FIG. 1) is hydrogen generated by electrolysis. The mixed fluid discharged from the fluid lead-out opening 39b (see FIG. 1) contains unreacted hydrogen that has not been electrolyzed and water vapor.

The through hole 40h is formed in the electrolyte membrane 40 at substantially the center in the radial direction. The through hole 40h is a part of the high pressure fluid discharging hole 38c provided in the electrolysis cell 12. A first electrode catalyst layer 42a is provided on a part of one surface of the electrolyte membrane 40. The part of the one surface of the electrolyte membrane 40 on which the first electrode catalyst layer 42a is provided is positioned between a portion surrounding a periphery of the through hole 40h and a marginal edge portion of an outer circumferential edge. A second electrode catalyst layer 44a is provided on a part of the other surface of the electrolyte membrane 40. The part of the other surface of the electrolyte membrane 40 on which the second electrode catalyst layer 44a is provided is positioned between the portion surrounding a periphery of the through hole 40h and the marginal edge portion of the outer circumferential edge. The first electrode catalyst layer 42a and the second electrode catalyst layer 44a are formed respectively in, for example, a ring shape.

The electrolyte membrane 40 includes a covered portion 40a covered with the pair of electrode catalyst layers 42a, 44a, and an exposed portion 40b not covered with the electrode catalyst layers 42a, 44a. In the electrolysis cell 12, a range corresponding to the covered portion 40a in the stacking direction is an electrolysis region. The exposed portion 40b is positioned respectively on the center side and the outer side of the electrolysis region in the radial direction, in other words, in the portion of the electrolyte membrane 40 around the through hole 40h and the marginal edge portion of the outer circumferential edge of the electrolyte membrane 40. Hereinafter, of the exposed portion 40b, the portion of the electrolyte membrane 40 around the through hole 40h is also referred to as a first exposed portion 41a. Further, of the exposed portion 40b, the portion on the outer side of the electrolysis region in the radial direction (marginal edge portion of the outer circumferential edge) is also referred to as a second exposed portion 41b.

The exposed portion 40b of the electrolyte membrane 40 has a smaller ion exchange capacity (IEC) than the covered portion 40a. The ion exchange capacity here is the reciprocal (meq/g) of the weight of the electrolyte membrane 40 in a dry state required to allow exchange of 1 mol of ions.

The first electrode catalyst layer 42a uses a ruthenium (Ru)-based catalyst, and the second electrode catalyst layer 44a uses a platinum catalyst, for example. The first current collector 42 and the second current collector 44 are constituted, for example, from a spherical gas atomizing titanium powder sintered compact (porous conductor), for example. The first current collector 42 and the second current collector 44 are provided with a smooth surface portion on which an etching process is performed after grinding, and the porosity thereof is set within a range of 10% to 50%, and more preferably, within a range of 20% to 40%.

The inner diameter and the outer diameter of the first current collector 42 and the second current collector 44 are set so as to be positioned correspondingly to the electrolysis region. Therefore, the inner ends of the first current collector 42 and the second current collector 44 on the radial center side are arranged at interval from the high pressure fluid discharging hole 38c in the radial direction.

The frame 42e is fitted to the outer circumference in the first current collector 42. The frame 42e is configured to be denser than the first current collector 42. The frame 42e can be formed by extending the outer circumference of the first current collector 42 outward from the electrolysis region in the radial direction and making the extending portion dense.

The first current collector 42 is accommodated in the first chamber 45an defined by the first separator 32, the resin frame member 36 and the electrolyte membrane 40. The second current collector 44 is accommodated in the second chamber 45ca defined by the second separator 34, the resin frame member 36 and the electrolyte membrane 40.

A flow path member 46 is interposed between the first separator 32 and the first current collector 42 (in the first chamber 45an), and a protective sheet member 48 is interposed between the first current collector 42 and the first electrode catalyst layer 42a. As shown in FIG. 2, the flow path member 46 has a substantially disc-like shape, and an inlet protrusion 46a and an outlet protrusion 46b, which are mutually opposed in the diametrical direction, are formed on an outer circumferential portion thereof.

A supply connection path 50a, which communicates with the fluid inlets 38a, is formed in the inlet protrusion 46a and is in communication with a flow path 50b (see FIG. 3). A plurality of holes 50c communicate with the flow path 50b and open toward the first current collector 42. A discharge connection path 50d, which communicates with the flow path 50b, is formed in the outlet protrusion 46b, and the discharge connection path 50d communicates with the fluid outlet 38b.

As shown in FIGS. 2 and 3, the protective sheet member 48 has a substantially circular shape when viewed in the stacking direction, and has an inner circumference arranged inward of the inner circumference of the first current collector 42 and an outer circumference arranged at the same position as the outer circumferences of the electrolyte membrane 40 and the frame 42e. The protective sheet member 48 is formed of an inner portion 48a and a frame portion 48b. The inner portion 48a is surrounded by the frame portion 48b. The inner portion 48a faces the covered portion 40a. The inner portion 48a is arranged in the range of the electrolysis region. The outer edge of the electrolysis region and the outer edge of the inner portion 48a coincide with each other, but are not limited thereto. A plurality of communication holes 48c are formed in the inner portion 48a. The frame portion 48b is positioned radially outward of the inner portion 48a. Rectangular holes (not shown) are, for example, formed in the frame portion 48b.

As shown in FIG. 3, the protective sheet member 48 and the membrane electrode assembly 30 are joined at a joint 49. The joint 49 joins the frame portion 48b of the protective sheet member 48 to the second exposed portion 41b of the electrolyte membrane 40. The joint 49 is positioned between a boundary point P1 between the inner portion 48a and the frame portion 48b of the protective sheet member 48 and an outer circumferential end E1 of the frame portion 48b. The joint 49 is not in contact with the boundary point P1 and is positioned away from the boundary point P1. Similarly, the joint 49 is not in contact with the outer circumferential end E1 and is positioned away from the outer circumferential end E1. Preferably, the joint 49 is provided substantially in the middle between the boundary point P1 and the outer circumferential end E1.

In the present embodiment, the joint 49 is positioned outward of the boundary point P1 and inward of a pressure-resistant member 74 to be described later. In the case where the joint 49 is positioned inwardly of the pressure-resistant member 74, the joint 49 is not interposed between the pressure-resistant member 74 and the protective sheet member 48. Therefore, a tolerance due to the joint 49 is less likely to be required in the thickness direction (stacking direction) of the electrolysis cell 12.

Between the central portions of the first separator 32 and the electrolyte membrane 40, a substantially cylindrical communication hole body 52, which surrounds the high pressure fluid discharging hole 38c is arranged. Hereinafter, the flow path member 46, the first current collector 42, and the protective sheet member 48 may be collectively referred to as a first electrode side member. In this case, the communication hole body 52 is arranged between the high pressure fluid discharging hole 38c and the first electrode side member in the radial direction of the high pressure fluid discharging hole 38c.

The communicating hole body 52 has an inside pipe member 54 made of a porous body facing toward the high pressure fluid discharging hole 38c, and an outside pipe member 55 arranged between the inside pipe member 54 and the first electrode side member. Accommodating chambers 55a, 55b are provided on a side of the outside pipe member 55 that faces toward the inside pipe member 54. The accommodating chambers 55a, 55b are formed by cutting out the radially inner side of the outside pipe member 55 into ring-like shapes at both ends in the axial direction (stacking direction), and seal members (O-rings) 56a, 56b are arranged in the accommodating chambers 55a, 55b to surround the high pressure fluid discharging hole 38c. Owing to this feature, the high pressure fluid discharging hole 38c is sealed from the first chamber 45an (on the side of the first current collector 42).

As shown in FIGS. 2 and 3, on a side of the outside pipe member 55 facing toward the first electrode side member, a groove 55s on which the protective sheet member 48 is disposed is formed on an end surface thereof that faces toward the electrolyte membrane 40.

The second current collector 44 and a load applying mechanism 58 (FIG. 3) which presses the second current collector 44 against the second electrode catalyst layer 44a are disposed in the second chamber 45ca. The load applying mechanism 58 is equipped with a conductive elastic member, for example, a plate spring 60, or the like, and the plate spring 60 applies a load to the second current collector 44 via a metal plate spring holder (shim member) 62. As the elastic member, in addition to the plate spring 60, a disc spring, a coil spring, or the like may be used.

On the radially inner side of the electrolysis region in the second chamber 45ca, for example, a resin sheet 68 is disposed as an insulating member that covers the first exposed portion 41a of the electrolyte membrane 40. The thickness of the resin sheet 68 is set to be substantially the same as the second current collector 44 and the shape of the resin sheet 68 is a ring shape with the high pressure fluid discharging hole 38c extending substantially at the center in the radial direction. As the resin sheet 68, for example, PEN (polyethylene naphthalate), a polyimide film, or the like may be used.

A conductive sheet 66 is disposed on the surfaces of the second current collector 44 and the resin sheet 68 on the plate spring holder 62 side. The conductive sheet 66 is constituted, for example, from a metal sheet of titanium, SUS, iron, or the like, and includes a ring-like shape with the high pressure fluid discharging hole 38c extending at substantially the center in the radial direction.

A tubular member 70 is disposed between the load applying mechanism 58 and the high pressure fluid discharging hole 38c in the radial direction and between the conductive sheet 66 and the second separator 34 in the stacking direction. The tubular member 70 has a cylindrical shape made of a conductive material such as metal, for example, with the high pressure fluid discharging hole 38c extending at substantially the center in the radial direction. At one end surface, which faces toward the second separator 34, of the tubular member 70, a discharge passage 71 is formed that communicates with the second chamber 45ca and the high pressure fluid discharging hole 38c.

As described above, by arranging the communication hole body 52 (outside pipe member 55) and the tubular member 70 between the first separator 32 and the second separator 34, the load bearing characteristics can be improved in the vicinity of the high pressure fluid discharging hole 38c of the electrolysis cell 12. The electrolyte membrane 40 (first exposed portion 41a), the resin sheet 68, and a portion of the conductive sheet 66 on the radially inner side of the electrolysis region (a portion near the high pressure fluid discharging hole 38c) are sandwiched between the communication hole body 52 and the tubular member 70.

A seal member (O-ring) 72 is disposed on the radially outer side of the electrolysis region in the second chamber 45ca so as to be interposed between the second exposed portion 41b of the electrolyte membrane 40 and the second separator 34. The pressure-resistant member 74 is disposed on the outer circumference of the seal member 72. The pressure-resistant member 74 has a substantially ring-like shape, together with the outer circumferential portion thereof being fitted into the inner circumferential portion of the resin frame member 36.

In the electrolysis cell 12, a conductive passage electrically connected from the second separator 34 to the tubular member 70, the conductive sheet 66, and the second current collector 44, and a conductive passage electrically connected from the second separator 34 to the plate spring 60, the plate spring holder 62, the conductive sheet 66, and the second current collector 44 are formed.

Although not shown, a pipe connected to the high pressure fluid discharging hole 38c is provided in the end plate 20a shown in FIG. 1, and a back pressure mechanism capable of regulating the discharge of gas via the high pressure fluid discharging hole 38c is provided in the pipe.

Basically, the electrolysis stack 10 is configured as described above. Next, a method for producing the electrolysis stack 10 will be briefly described with reference to FIG. 1.

First, on a jig (not shown) used for producing the electrolysis stack 10, the layers are stacked in a direction opposite to the direction from top to bottom shown in FIG. 1. That is, the end plate 20a, the insulating plate 18a, and the terminal plate 16a are stacked in this order. Next, the plurality of electrolysis cells 12 are stacked on the terminal plate 16a. Then, the terminal plate 16b, the insulating plate 18b, and the end plate 20b are stacked in this order on the last stacked electrolysis cell 12. Thereafter, the end plates 20a, 20b are held in an integrally fastened state by a pressing mechanism such as a plurality of tie rods 22. In this way, the electrolysis stack 10 is produced.

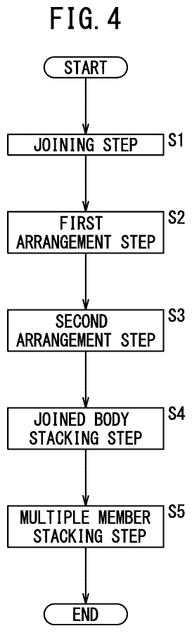

Next, a method for producing the electrolysis cell 12 will be described. FIG. 4 is a flowchart illustrating a procedure of a method for producing the electrolysis cell 12. The method for producing the electrolysis cell 12 includes a joining step S1, a first arrangement step S2, a second arrangement step S3, a joined body stacking step S4, and a multiple member stacking step S5.

The method for producing the electrolysis cell 12 is performed in the order of the joining step S1, the first arrangement step S2, the second arrangement step S3, the joined body stacking step S4, and the multiple member stacking step S5, but is not limited thereto. For example, the joining step S1 may be performed between the first arrangement step S2 and the second arrangement step S3. Alternatively, the joining step S1 may be performed between the second arrangement step S3 and the joined body stacking step S4.

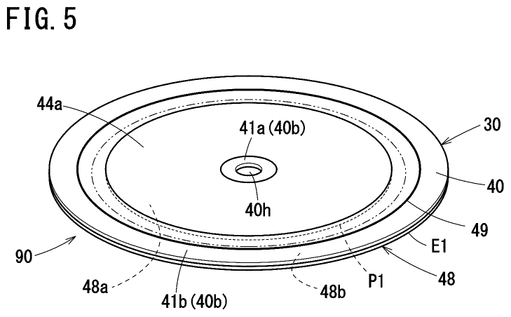

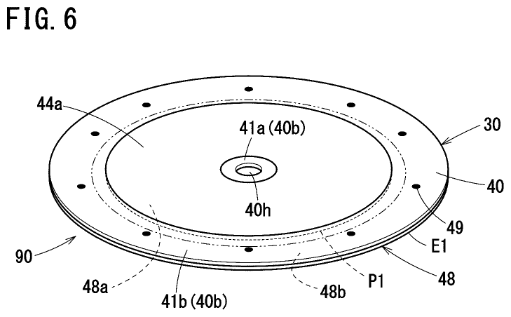

The joining step S1 is a process of forming the joint 49 by joining the frame portion 48b of the protective sheet member 48 to a portion of the membrane electrode assembly 30 on the outer side of the covered portion 40a (the second exposed portion 41b of the electrolyte membrane 40). A joined body 90 is obtained by the joining step S1 (see FIGS. 5 and 6). The joined body 90 is formed of the protective sheet member 48 and the membrane electrode assembly 30 joined at the joint 49.

As shown in FIG. 5, the joint 49 may be provided in a ring shape surrounding the inner portion 48a. In this case, the joint 49 is provided in a ring shape concentric with the boundary position P1 on the outer side of the boundary position P1 that is formed in a substantially circular shape when viewed from the stacking direction. Further, the joint 49 is provided in the ring shape concentric with the outer circumferential end E1 on the inner side of the outer circumferential end E1 of the frame portion 48b that is formed in a substantially circular shape when viewed from the stacking direction. The joint 49 may be provided in the ring shape concentric with the boundary position P1 and the outer circumferential end E1 in the middle of the boundary position P1 and the outer circumferential end E1 that are provided in a substantially circular shape.

Alternatively, as shown in FIG. 6, the joint 49 is concentric with the boundary position P1 or the outer circumferential end E1 formed in a substantially circular shape when viewed from the stacking direction, but may be provided in plurality at intervals from each other in the circumferential direction of the protective sheet member 48.

The joint 49 is formed by fusion or welding, but is not limited thereto. For example, the joint 49 may be formed of an adhesive. When the joint 49 is provided in a ring shape surrounding the inner portion 48a, the joint 49 is preferably formed by fusion or welding.

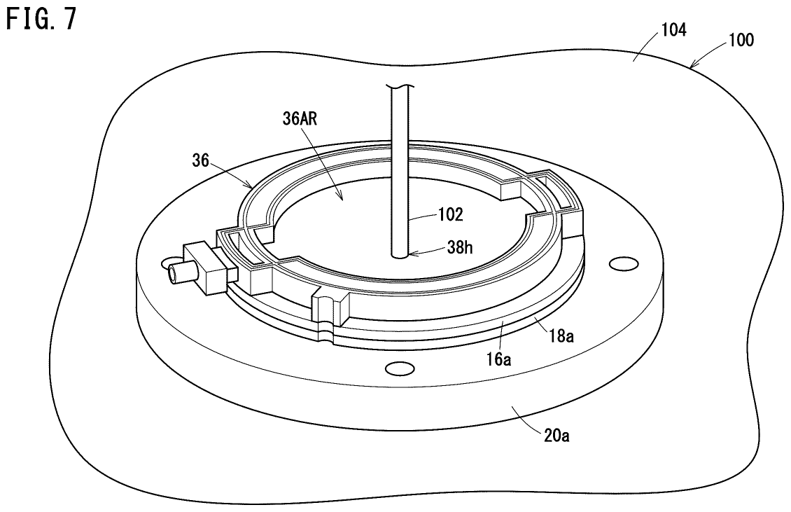

The first arrangement step S2 is a process of arranging the resin frame member 36. To be more specific, as shown in FIG. 7, a guide rod 102 of the jig 100 is inserted into the high pressure fluid discharging hole 38h of the resin frame member 36, whereby the resin frame member 36 is positioned. The guide rod 102 is fixed to the placement table 104 of the jig 100 and extends along the vertical direction. Therefore, the guide rod 102 restricts the positional deviation of the resin frame member 36 in the direction orthogonal to the guide rod 102 (the radial direction of the electrolysis cells 12).

FIG. 7 shows a state where the electrolysis cell 12 to be stacked first is produced. In this case, the resin frame member 36 is disposed on the terminal plate 16a. Although not shown in the drawings, in a state where the n-th electrolysis cell 12 is to be stacked (n is an integer of 2 or more), the n-th resin frame member 36 is disposed on the already-stacked first separator 32 (or the second separator 34) of the n-th electrolysis cell 12.

The second arrangement step S3 is a step of arranging the flow path member 46 (FIG. 2), the first current collector 42 (FIG. 2), the seal members 56a, 56b (FIG. 2), the outside pipe member 55 (FIG. 2), and the inside pipe member 54 (FIG. 2). Specifically, as shown in FIG. 2, a guide rod 102 (FIG. 7) is inserted into the inner space of the inside pipe member 54. Next, the seal member 56b, the outside pipe member 55, and the seal member 56a are arranged around the inside pipe member 54 such that the inner pipe member 54 is inserted into the seal member 56b, the outside pipe member 55, and the seal member 56a. Next, the outside pipe member 55 is inserted into the through hole 46h of the flow path member 46, and thus the flow path member 46 is arranged in the accommodation space 36AR inside the resin frame member 36. Next, the outside pipe member 55 is inserted into the through hole 42h of the of the first current collector 42, and thus the first current collector 42 is arranged in the accommodation space 36AR. The inside pipe member 54 into which the guide rod 102 is inserted and the outside pipe member 55 into which the inside pipe member 54 inserted to restrict the positional deviation of the flow path member 46 and the first current collector 42 in the direction orthogonal to the guide rod 102. The inner space of the inside pipe member 54 forms a part of the high pressure fluid discharging hole 38c.

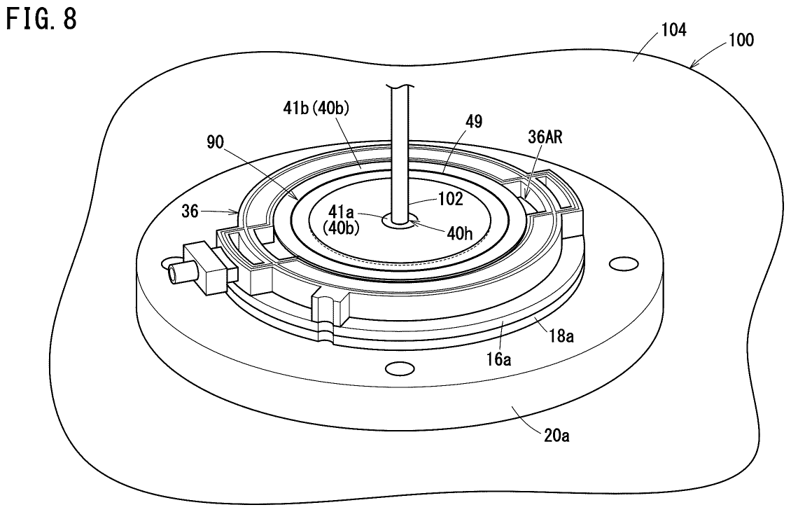

The joined body stacking step S4 is a step of stacking the joined body 90 obtained in the joining step S1. The guide rod 102 (FIG. 7) is inserted into the through hole 40h (FIG. 5 or 6) formed in the electrolyte membrane 40 of the joined body 90. Thus, the joined body 90 is stacked on the first current collector 42 in a state where the protective sheet member 48 faces the first current collector 42 (FIG. 2). FIG. 8 shows a state in which the joined body 90 shown in FIG. 5 is stacked.

The guide rod 102 is inserted into the through hole 40h of the electrolyte membrane 40 of the joined body 90. Therefore, the membrane electrode assembly 30 (FIG. 5) is prevented from being displaced in a direction orthogonal to the guide rod 102. The protective sheet member 48 (FIG. 5) has been joined to the membrane electrode assembly 30. Therefore, the protective sheet member 48 is also restricted from being displaced in the direction orthogonal to the guide rod 102.

The multiple member stacking step S5 is a step of stacking multiple of members on the joined body 90. Specifically, the pressure-resistant member 74 (FIG. 2), the second current collector 44 (FIG. 2), the resin sheet 68 (FIG. 2), the conductive sheet 66 (FIG. 2), the plate spring holder 62 (FIG. 2), the plate spring 60 (FIG. 2), the tubular member 70 (FIG. 2), and the second separator 34 (FIG. 2) are stacked in this order. The guide rod 102 (FIG. 7) is inserted through each of these members.

When the multiple member stacking step S5 is completed, one electrolysis cell 12 is manufactured. The guide rod 102 is removed after a plurality of electrolysis cells 12 are produced (stacked) by repeating the above-described producing method. Thereafter, as described above, the terminal plate 16b, the insulating plate 18b, and the end plate 20b are stacked in this order, and the end plates 20a, 20b are integrally fastened.

In a case where the protective sheet member 48 is not joined to the membrane electrode assembly 30 at the joint 49, a restricting member is required to restrict positional displacement of the protective sheet member 48 in a direction orthogonal to the guide rod 102 (radial direction of the electrolysis cell 12). The reason therefor is as follows. That is, as shown in FIG. 2, in order to dispose the seal member 56a (FIG. 2), the through hole 48h (FIG. 2) of the protective sheet member 48 should be larger than the through hole 40h of the electrolyte membrane 40. Therefore, in a stage before the end plates 20a, 20b are integrally fastened, there is a concern that the relatively large clearance existing between the through hole 48h (FIG. 2) of the protective sheet member 48 and the guide rod 102 inserted into the through hole 48h may cause positional deviation of the protective sheet member 48. Therefore, when the protective sheet member 48 is not joined to the membrane electrode assembly 30 at the joint 49, another restricting member is required.

In contrast, in the present embodiment, the protective sheet member 48 is stacked on the fluid-supply-side current collector (first current collector 42) after being joined to the membrane electrode assembly 30 at the joint 49. The clearance between the through hole 40h of the electrolyte membrane 40 of the membrane electrode assembly 30 and the guide rod 102 inserted into the through hole 40h is small. Thus, the guide rod 102 restricts displacement of the protective sheet member 48 in a direction orthogonal to the guide rod 102 via the membrane electrode assembly 30. Therefore, even if there is no restricting member dedicated to the protective sheet member 48, the positional deviation of the protective sheet member 48 in the direction orthogonal to the guide rod 102 can be restricted. In this way, the risk of misalignment during the manufacture of the electrolysis cell 12 can be reduced.

In the present embodiment, as shown in FIG. 3, the joint 49 is positioned away from each of the boundary position P1 between the inner portion 48a and the frame portion 48b of the protective sheet member 48 and the outer circumferential end El of the frame portion 48b. Therefore, the joint strength between the protective sheet member 48 and the membrane electrode assembly 30 can be increased as compared to the case where the joint 49 is not away from the boundary position P1 or the outer circumferential end E1.

In the present embodiment, the joint 49 is formed by fusion or welding. Therefore, the protective sheet member 48 and the membrane electrode assembly 30 can be joined together more easily without distortion than in the case where the joint 49 is formed of an adhesive or the like.

As shown in FIG. 5, when the joint 49 is formed in a ring shape surrounding the inner portion 48a, the joint strength between the protective sheet member 48 and the membrane electrode assembly 30 can be increased. In this case, the formation of the joint 49 by fusion or welding is facilitated.

The following supplementary notes are further disclosed in relation to the above embodiment.

### Supplementary Note 1

The method for producing the electrolysis cell (12) according to the present disclosure includes: the membrane electrode assembly (30) including the electrolyte membrane (40) with the through hole (40h) and the pair of electrode catalyst layers (42a, 44a) provided respectively on both surfaces of the electrolyte membrane and covering the electrolyte membrane in the range extending between the portion surrounding the periphery of the through hole to the marginal edge portion of the outer circumference; the pair of current collectors (42, 44) provided respectively on both sides of the membrane electrode assembly; and the protective sheet member (48) disposed between one of the pair of current collectors and the membrane electrode assembly, wherein the one of the pair of current collectors is the fluid-supply-side current collector (42) to which the fluid to be used for electrolysis is supplied, and the protective sheet member includes the inner portion (48a) facing the electrolyte membrane in the range (40a) covered with the electrode catalyst layers and the frame portion (48b) surrounding the inner portion, the method for producing the electrolysis cell including the joining step (S1) of forming the joint (49) by joining the frame portion to the portion of the membrane electrode assembly at the position outward of the range covered with the catalyst layers; and the joined body stacking step (S4) of stacking on the fluid-supply-side current collector the membrane electrode assembly and the protective sheet member that have been joined, in a manner that the protective sheet member faces the fluid-supply-side current collector.

### Supplementary Note 2

In the method for producing an electrolysis cell according to Supplementary Note 1, the joint may be positioned away from each of the outer circumferential end (E1) of the frame portion and the boundary position (P1) between the inner portion and the frame portion.

### Supplementary Note 3

In the method for producing an electrolysis cell according to Supplementary Note 1, the joint may be provided in plurality at intervals from each other in the circumferential direction of the protective sheet member.

### Supplementary Note 4

In the method for producing an electrolysis cell according to Supplementary Note 1, the joint may be formed by fusion or welding.

### Supplementary Note 5

In the method for producing an electrolysis cell according to Supplementary Note 4, the joint may be formed in the ring shape surrounding the inner portion.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A method for producing an electrolysis cell comprising:
a membrane electrode assembly including: an electrolyte membrane with a through hole; and a pair of electrode catalyst layers provided respectively on both surfaces of the electrolyte membrane and covering the electrolyte membrane in a range extending between a portion surrounding a periphery of the through hole to a marginal edge portion of an outer circumferential edge;
a pair of current collectors provided respectively on both sides of the membrane electrode assembly; and
a protective sheet member disposed between one of the pair of current collectors and the membrane electrode assembly,
wherein the one of the pair of current collectors is a fluid-supply-side current collector to which a fluid to be used for electrolysis is supplied, and
the protective sheet member includes an inner portion facing the electrolyte membrane in the range covered with the electrode catalyst layers and a frame portion surrounding the inner portion, the method for producing the electrolysis cell comprising:
a joining step of forming a joint by joining the frame portion to a portion of the membrane electrode assembly at a position outward of the range covered with the catalyst layers; and
a joined body stacking step of stacking on the fluid-supply-side current collector the membrane electrode assembly and the protective sheet member that have been joined, in a manner that the protective sheet member faces the fluid-supply-side current collector.

2. The method for producing the electrolysis cell according to claim 1, wherein
the joint is positioned away from each of an outer circumferential end of the frame portion and a boundary position between the inner portion and the frame portion.

3. The method for producing the electrolysis cell according to claim 1, wherein
the joint is provided in plurality at intervals from each other in a circumferential direction of the protective sheet member.

4. The method for producing the electrolysis cell according to claim 1, wherein
the joint is formed by fusion or welding.

5. The method for producing the electrolysis cell according to claim 4, wherein
the joint is formed in a ring shape surrounding the inner portion.
